(19) United States
(12) Patent Application Publication
(10) Pub. No.: US 2026/0001013 A1
(43) Pub. Date: Jan. 1, 2026

(54) Anti-Static Stinger Apparatus and Method of Using Same

(71) Applicant: The Oscar W. Larson Company, Clarkston, MI (US)

(72) Inventors: Gaines Garrett, Baton Rouge, LA (US); David Tiede, Baton Rouge, LA (US); Joshua Crochet, Baton Rouge, LA (US)

(21) Appl. No.: 19/252,246

(22) Filed: Jun. 27, 2025

Related U.S. Application Data
(60) Provisional application No. 63/664,899, filed on Jun. 27, 2024.

(51) Int. Cl. B01D 35/02; B01D 35/14; B01D 35/26

(52) U.S. Cl. CPC B01D 35/02; B01D 35/14; B01D 35/26; B01D 2201/4007; B01D 2201/50

(57) ABSTRACT

A device for use in cleaning fuel tanks that are used for fuel storage, while simultaneously preventing an electrical charge or spark from being created while in the process of cleaning. An apparatus that is manufactured with an anti-static additive or agent to reduce the accumulation of static electricity in order to safely extract and remove particulates and impurities from a fuel tank.

### BACKGROUND OF THE INVENTION

### Field of the Invention

The present invention pertains to a device for use in cleaning fuel tanks that are used for fuel storage. More particularly, the present invention pertains to an anti-static smart stinger apparatus which is used to clean fuel tanks, while simultaneously prevents an electrical charge or spark from being created while in the process of cleaning.

### Brief Description of the Prior Art

Anti-static tools are carefully designed to work within a system of grounding equipment in order to prevent static electricity from building to the point that it could damage electronics or provide enough of a charge to start a fire or explosion.

Electronics components—especially motherboards—are extremely electrostatic discharge (ESD) sensitive. For example, a simple static charge created by a worker walking across a floor to a workstation could destroy a motherboard, rendering the entire component useless. Most industries do not need to worry about static discharge, but when flammable gas is in the air, such as acetone or methane, even a small discharge can create a fire or explosion.

Anti-static tools are more complex than not containing a specific type of metal. They must be a part of a complete program to safely discharge static.

Static electricity naturally builds up through three different processes:
(1) Tribocharging: Two materials (like socks and carpet) are brought into contact and then separated.
(2) Electrostatic induction: An electrically charged object is placed near a conductive object that isn't grounded.
(3) Energetically charged particles impinge on an object: This is mostly a problem for spacecraft.

The most effective prevention for static electricity is not so much a single tool, as it is a system of precautions, grounding mechanisms and a lack of highly charged materials. Together, this creates an Electrostatic Discharge Protection Area (EPA) that works to keep electrostatic discharge (ESD) sensitive materials safe.

The principles of a successful EPA include:
1. No highly charged materials;
2. All conductive materials are grounded;
3. Workers are grounded; and
4. Electrostatic charge builds up on ESD-sensitive electronics is prevented.

The hand tools that are used in this environment are often made from plastics that are specifically created to work within this delicately balanced system. These electrostatic dissipative tools have a balanced charge and low surface resistivity, which means they do not gain or lose charge to the objects and surfaces that surround them. These tools have precise temperature and humidity ranges that they work in. If they're used outside those ranges, they may still create a static charge.

When it comes to cleaning fuel tanks, the current industry standard is to run a grounded, flexible polyvinyl chloride (PVC) tubing through a stainless-steel pipe in order to stir up sludge on a bottom surface of a fuel tank and attempt to remove as much of that sludge as possible. This process requires the removal of a large volume of fuel at high speeds and therefore results in putting much of those contaminants into suspension. The flexible PVC tubing is also very hard to control or to direct in any specific fashion, meaning that all areas of the tank are not properly swept or cleaned.

As a result, the present invention has solved all of these issues with the development of the anti-static smart stinger apparatus. Traditionally, rigid PVC or other plastic tubes were not an option due to each material's ability to hold and maintain a static charge in excess of 1 kilovolt per centimeter (kV/cm). At that value, a micro spark can be generated, thereby creating a major safety concern when working in and around combustible liquids, such as fuel. As such, the present invention comprises an anti-static rigid tubing that is able to hold a static charge of less than 0.5 kilovolt per centimeter, which is 4 times less than traditional PVC (2 kV/cm) and 50% below the 1 kV/cm threshold.

### SUMMARY OF THE INVENTION

The present invention comprises an anti-static stinger apparatus, wherein said apparatus is manufactured from a polyvinyl chloride (PVC) material with an anti-static agent or additive incorporated into said PVC material during the extrusion process. Said anti-static additive is used to reduce the accumulation of static electricity, thereby resulting in safe operation in environments where flammable fuels or vapors are present, such as cleaning fuel tank. Said anti-static stinger apparatus comprises a substantially straight cylindrical tubing having a first end and a second end, wherein said first end comprises a quick connect and said second end comprises a bell connector. Additionally, said anti-static stinger of the present invention comprises a substantially curved cylindrical tubing having a first end and a second end, wherein said first end comprises a bell connection receiver and said second end comprises a “T” connection. Said first end of said curved tubing is attachably connected to said second end of said straight tubing by way of attachably connecting said bell connector over the top of said bell connection receiver end. Once attachably connected, said anti-static stinger is ready for use.

The rigid plastic stinger of the present invention can be easily directed by a technician to all areas of the fuel tank, thereby resulting in the most comprehensive bottom surface sweep in the industry. The stinger comprises a nozzle, wherein said nozzle can sit directly on a bottom surface, thus allowing the technicians to remove any present waste and sludge without creating excess waste or stirring up the fuel.

The anti-static stinger of the present invention is connected to a filtration rig by using at least one cam and groove fitting connection. The stinger has a female “cam and groove” fitting and the hose has a male “cam and groove” fitting that attachably connect to each other. The hose is then run to the filtration rig and attachably connected by a similar connection method or means. The only difference is the hose has the female connection and the filtration rig has the male connection.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts an aerial view of a preferred embodiment of a cam and groove connection end on an anti-static stinger apparatus of the present invention.

FIG. 2 depicts an aerial view of a preferred embodiment of a female cam and groove connection of said anti-static stinger apparatus of the present invention with a male cam and groove connection on a hose.

FIG. 3 depicts an aerial view of a preferred embodiment of a male cam and groove connection on a hose received within a female cam and groove connection of said anti-static stinger apparatus of the present invention.

FIG. 4 depicts an aerial view of a preferred embodiment of a male cam and groove connection on a hose received within a female cam and groove connection of said anti-static stinger apparatus of the present invention, wherein said hose is secured within said anti-static stinger apparatus.

FIG. 5 depicts a perspective view of a preferred embodiment of an anti-static stinger apparatus of the present invention attachably connected to a filtration rig.

FIG. 6 depicts a side view of a preferred embodiment of a straight cylindrical tube of an anti-static stinger apparatus of the present invention.

FIG. 7 depicts a side view of a preferred embodiment of a straight cylindrical tube and a curved cylindrical tube of an anti-static stinger apparatus of the present invention.

FIG. 8a depicts a side view of an alternate embodiment of an anti-static stinger apparatus of the present invention comprising a union connection that is in a disconnected orientation.

FIG. 8b depicts a side view of an alternate embodiment of an anti-static stinger apparatus of the present invention comprising a union connection that is in a connected orientation.

FIG. 9 depicts a side view of a preferred embodiment of an anti-static stinger apparatus of the present invention in use and operation.

### DETAILED DESCRIPTION OF A PREFERRED EMBODIMENT

The present invention comprises an anti-static stinger apparatus 100 for use in cleaning fuel tanks. Said anti-static stinger apparatus 100 comprises at least one substantially cylindrical tube member that is attachably connected to a hose member and a filtration rig in order to conduct and operate the cleaning of a fuel tank. While the present invention can comprise at least one substantially cylindrical tube member, it is to be observed that in the present application, a substantially straight cylindrical tube member and a substantially curved cylindrical tube member are both referenced and utilized together.

In the preferred embodiment, the present invention comprises a straight cylindrical tube member having a first end and a second end, wherein said second end is adapted for connection to a fuel hose member and said first end is affixed to a curved cylindrical tube member. Said curved cylindrical tube member is configured to extend into an interior of a fuel tank in order to allow for the extraction of fuel, debris, and contaminants. Said fuel hose member comprises a first end and a second end, wherein said first end is fluidly connected to said second end of said straight tube member and said second end is coupled to a fuel filtration rig, wherein said filtration rig comprises one or more filters adapted to remove particulate matter, water, or any other impurities from the extracted fuel. Said fuel hose member, said straight cylindrical tube member, and said curved cylindrical tube member, when all attachably connected together, form a continuous fluid passageway in order to remove particulate from said fuel tank and pump said particulate towards said filtration rig.

Said cylindrical tube member is manufactured from a polyvinyl chloride (PVC) material, or any other similar material exhibiting like characteristics that is extruded to define a continuous, hollow cylindrical body; however, during the manufacturing process of said PVC tube, in order to reduce the accumulation of static electricity, which is particularly important in fuel-handling environments, an anti-static additive is incorporated into the PVC material during the pipe extrusion process. As such, when said anti-static additive is incorporated into said PVC tubing at the time of extrusion, it creates a conductive matrix in the final tubing product that prevents a static charge build up and lowers the static capacity in said tubing to approximately 0.5 kv/cm. This allows for the tubing to be used safely during the fuel tank cleaning process. By way of illustration, but not limitation, said anti-static additive can comprise a conductive carbon black, a quaternary ammonium compound, a polymeric antistatic masterbatch, or any other similar anti-static agent that can be used to lower the static capacity of the PVC tubing.

It is to be noted that every cylindrical tube member referenced herein is manufactured using said PVC tubing comprising said anti-static additive incorporated into said tubing during the extrusion process.

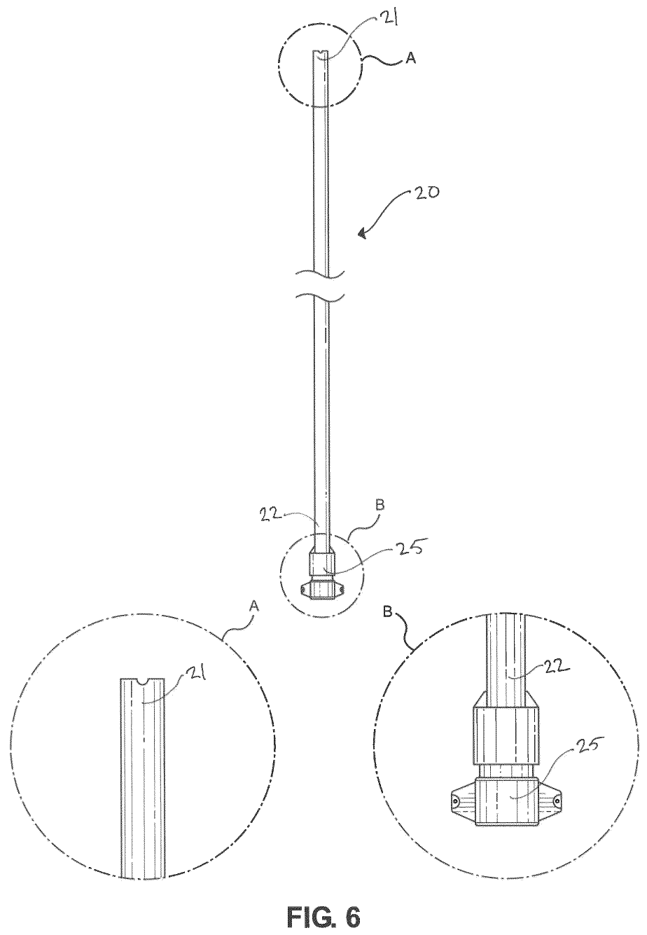

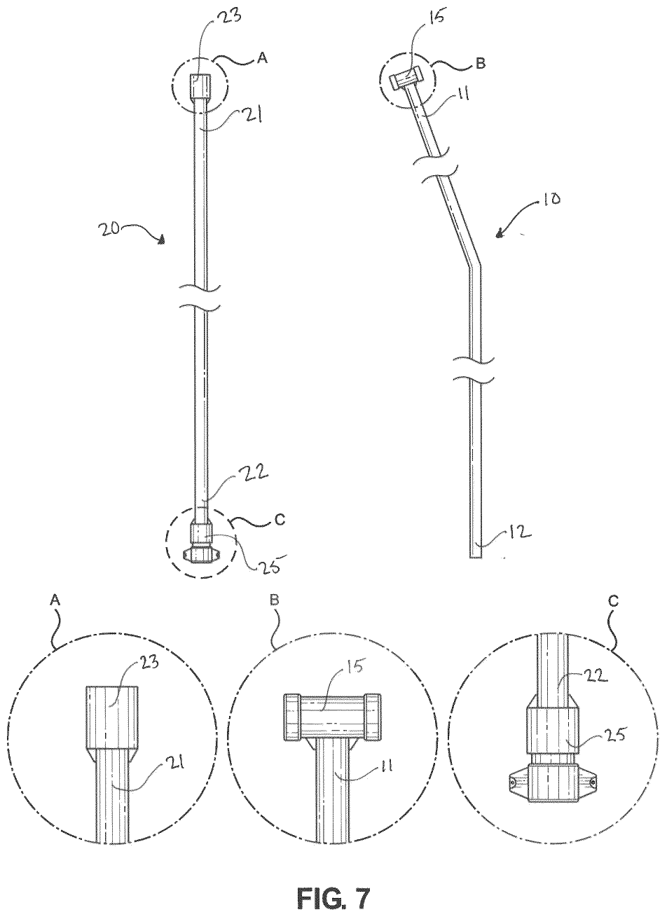

Referring to the drawings, FIG. 6 depicts a side view of a substantially straight cylindrical tube member 20 of the present invention, having a first end 21 and a second end 22. Said second end 22 of said straight tube member 20 comprises a cam and groove lock fitting 25 and adapter for use in being adapted for connection to a hose member 30 (although not depicted in FIG. 6). FIG. 7 depicts a side view of anti-static stinger apparatus 100 in a disassembled view, wherein said anti-static stinger apparatus 100 comprises straight cylindrical tube member 20 and a substantially curved cylindrical tube member 10. Said curved cylindrical tube member 10 further comprises a first end 11 and a second 12, wherein said first end 11 comprises a “T” fitting 15, wherein said “T” fitting comprises a nozzle for use in performing a bottom sweep of said fuel tank 5.

As depicted in FIG. 7, said first end 21 of straight tube member 20 comprises a bell end fitting 23 for use in attachably connecting to second end 12 of curved tube member 10. A bell end fitting 23 is a type of fitting used in joining tubulars. Said bell end fitting 23 is flared on at the first end 21 of said straight tube member 20 to create a larger connection diameter. The flared end fits over the second end 12 of the adjacent cylindrical tube member 10, where the joint is then welded or bolted together.

Although not illustrated in FIGS. 6 and 7, first end 21 of straight tube member 20 is attachably connected to second end 12 of curved tube member 10, and first end 11 of curved tube member 10 is inserted into a fuel tank 5. Second end 22 of straight tube member 20 is attachably connected to a fuel hose member 30, wherein said fuel hose member 30 is coupled to a filtration rig 40 in order to remove particulate and other impurities from said fuel tank 5.

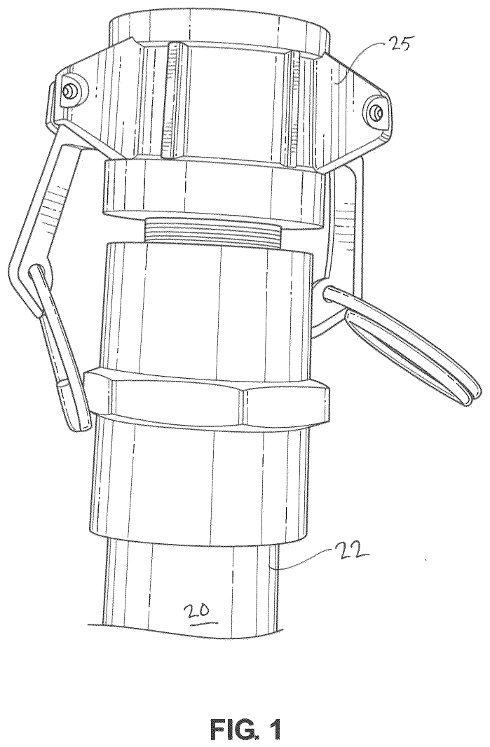

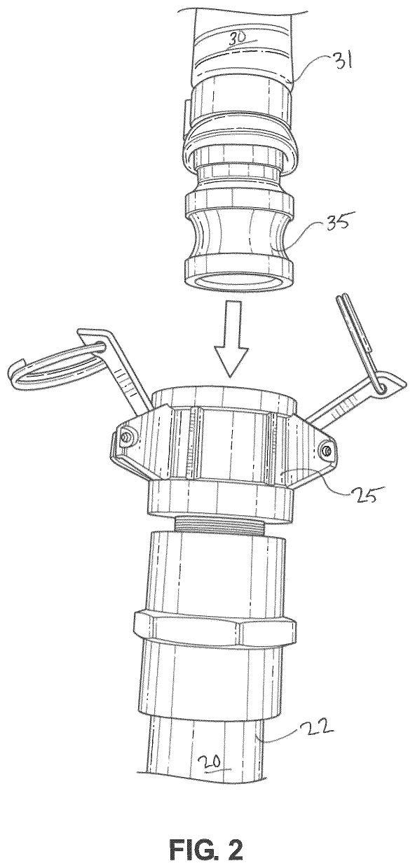

Referring back to the beginning of the drawings, FIG. 1 depicts an aerial view of second end 22 of straight tube member 20 comprising a female cam and groove fitting 25 in order to couple and attachably connect to a hose member (although not depicted in FIG. 1). FIG. 2 depicts an aerial view of second end 22 of straight tube member 20 comprising female cam and groove fitting 25 and a first end 31 of hose member 30 comprising a male cam and groove fitting 35. Male cam and groove fitting 35 on hose member 30 is being inserted into female cam and groove fitting 25 on straight tube member 20.

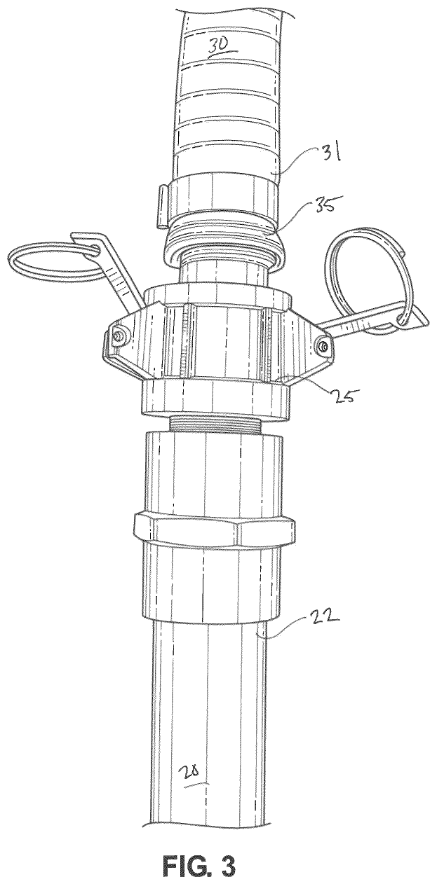

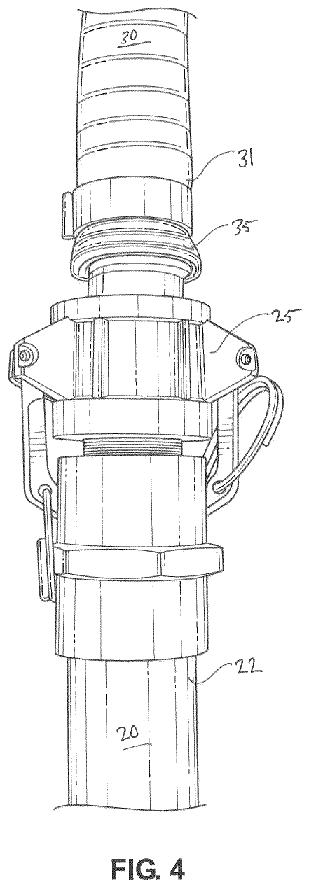

FIG. 3 depicts an aerial view of male cam and groove fitting 35 inserted within female cam and groove fitting 25. Female cam and groove fitting 25 comprises a plurality of—typically two (2)—arms 28 for use in locking into position on male cam and groove fitting 35. FIG. 4 depicts an aerial view of arms 28 locked into position and closed on male cam and groove fitting 35, thereby attachably securing hose member 30 to straight cylindrical tube member 20.

In securing the cam and groove fittings, the cams at the end of each lever on the female end align with a circumferential groove on the male end. When the levers are rotated to the locked position, they pull the male end into a female socket, creating a tight seal against a gasket within the female socket. The arms lock into position using over-center geometry, preventing accidental decoupling. Because the groove is cut all the way around the male end, there is no specific rotational alignment necessary to couple, as there would be with threaded connectors, and there is no opportunity for cross-threading. This results in a fast, error-resistant coupling operation. Because the compression between the two fittings is limited by the size of the cams on the end of the levers and the rotation of the levers themselves, there is also no possibility of over—or under—tightening the fitting; the pressure against the sealing gasket is effectively constant from one coupling operation to the next, reducing possibility of leaks.

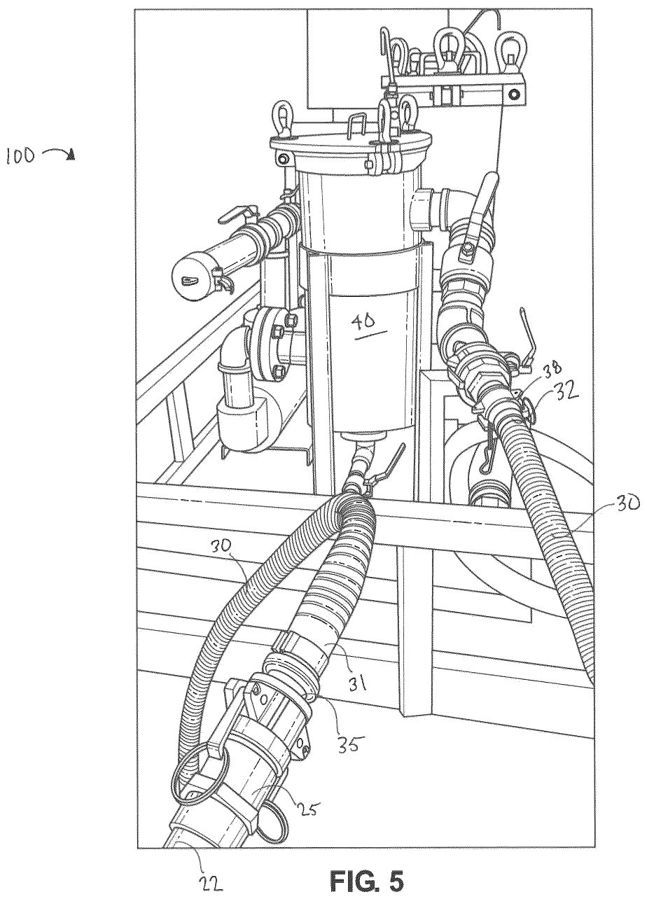

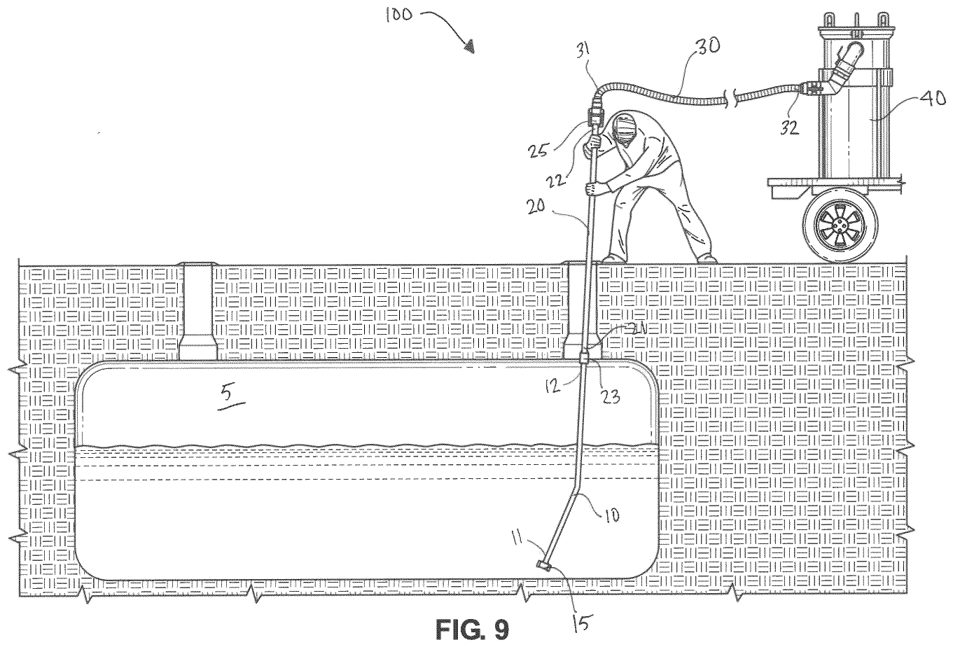

FIG. 5 depicts a perspective view of anti-static stinger apparatus 100 attachably connected to filtration rig 40, or any other similar filtration device, wherein fuel hose member 30 comprises a female cam and groove fitting 38 on a second end 32 of said hose member that is adapted to connect to a male cam and groove fitting located on an inlet of said filtration rig 40. Additionally, referring to FIG. 9, FIG. 9 depicts a side view of anti-static stinger apparatus 100 in use. As depicted in FIG. 9, anti-static stinger apparatus comprises curved tube member 10 attachably connected to straight tube member 20, wherein first end 11 of curved tube member 10 with “T” fitting 15 is inserted into a fuel tank 5 in order to clean said tank 5. Second end 12 of curved tube member 10 is attachably connected to first end 21 of straight tube member 20 by way of bell end fitting 25. Second end 22 of straight tube member is attachably connected and adapted to first end 31 of fuel hose member 30 by way of cam and groove fitting 25. Second end 32 of fuel hose member 30 is then adapted to filtration rig 40.

During operation, suction or pumping pressure that is applied by way of the filtration rig draws fuel contaminants from the fuel tank 5, through curved tube member 10, through straight tube member 20, and through fuel hose 30 towards filtration rig 40 for filtration and potential recovery or disposal. Said curved tube member 10, straight tube member 20, and fuel hose member 30 are adapted to connect to each other and form a continuous fluid passageway for particulates, impurities, or other contaminants to be removed from said fuel tank and disposed of through said filtration rig 40.

In setting up the filtration rig 40, a user should park as close to the tank 5 as possible. This will allow the user to use the least amount of fuel hose 30 and decrease the risk of a spill. The user will open the back gate on the trailer, which will ground out the trailer and thus prevent any sparks. The generator should be wheeled off of the trailer to a well-ventilated area, and the trailer should be surrounded with the spill boom. The user will hook up said fuel hose 30 to the intake outlet of said filtration rig 40. Said fuel hose 30 will connect to said anti-static stinger apparatus 100 that will be inserted into the fuel tank 5. The user will then hook up said fuel hose 30 to the discharge outlet. Said fuel hose 30 will be connected to said anti-static stinger apparatus 100 that will either go into the tank 5 or directly to a waste tote. The user will then power up the generator, and run the power cable to the generator and plug it in.

To operate the filtration rig 40, a user must first turn on the generator so that the pump will have a power source. The user will then make sure to open and close the ball valves (levers) according to the type of job that is being performed. The user will then place said anti-static stinger apparatus 100 into the fuel tank 5. On the variable frequency drive, or the pump controls, the filtration rig 40 comprises a green button that will turn on the pump and a red button that will shut down the pump. When the user is ready to begin, he or she will set the dial to about 30% (set to around 20 if your drive shows numbers instead of a dial) and press the green button on the variable frequency drive. The dial will adjust the speed of the pump. The user will adjust the speed depending on the job that is being performed and how the pump is handling the fuel. The type of speed that is used will vary depending on the type of job. 20-30% power should be efficient for most jobs. To stop the pump, the user will press the red button on the variable frequency drive or turn off the generator.

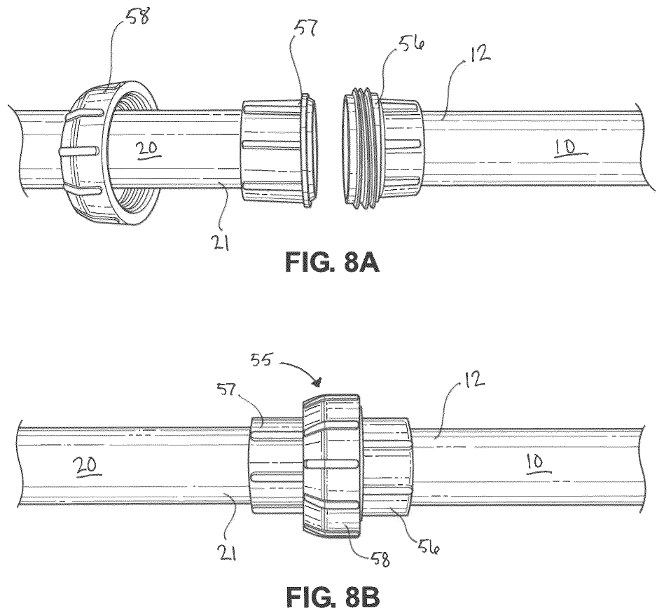

FIG. 8a depicts a side view of an alternate embodiment of a connection point between straight cylindrical tube member 20 and curved cylindrical tube member 10 in a disconnected orientation. FIG. 8b depicts a side view of an alternate embodiment of a connection point between straight cylindrical tube member 20 and curved cylindrical tube member 10 in a connected orientation. In FIGS. 8a and 8b, the connection point comprises a union connection 55 between second end 12 of curved tube member 10 and first end 21 of straight tube member 20. Union connection 55 comprises a type of fitting that allows for easy and secure connection and disconnection of tube members 10 and 20. Said union connection 55 comprises a three-part fitting comprising two end pieces 56 and 57 and a central nut 58, which when tightened, compresses the ends 56 and 57 together to create a leak-proof seal.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. An apparatus for extracting and filtering fuel contaminants from a fuel tank while preventing an electrical charge from being created, comprising:
(a) at least one substantially cylindrical tubular member, having a first end and a second end, wherein said cylindrical tubular member is manufactured from a polyvinyl chloride composition comprising an anti-static additive incorporated into said composition during an extrusion process; and
(b) a filtration device, comprising a power source and a pump, wherein said filtration device is adapted to connect to said cylindrical tubular member.

2. The apparatus of claim 1, further comprising a hose member, having a first end and a second end, wherein said first end of said hose member attachably connects to said second end of said cylindrical tubular member and said second end of said hose member attachably connects to said filtration device.

3. The apparatus of claim 2, wherein said hose member and said cylindrical tubular member are attachably connected by way of a cam and groove fitting.

4. The apparatus of claim 2, wherein said hose member and said filtration device are attachably connected by way of a cam and groove fitting.

5. An apparatus for extracting and filtering fuel contaminants from a fuel tank while preventing an electrical charge from being created, comprising:
(a) a substantially straight cylindrical tubular member, having a first end and a second end, wherein said straight cylindrical tubular member is manufactured from a polyvinyl chloride composition comprising an anti-static additive incorporated into said composition during an extrusion process;
(b) a substantially curved cylindrical tubular member, having a first end and a second end, wherein said first end is inserted into a fuel tank and said second end is attachably connected to said first end of said straight cylindrical tubular member, wherein said curved cylindrical tubular member is manufactured from a polyvinyl chloride composition comprising an anti-static additive incorporated into said composition during an extrusion process;
(c) a hose member, having a first end and a second end, wherein said first end is attachably connected to said second end of said straight cylindrical tubular member, wherein said straight cylindrical tubular member, said curved cylindrical tubular member and said hose member are removably joined together to form a continuous fluid pathway; and
(d) a filtration device, comprising a power source and a pump, wherein said filtration device is adapted to connect to said hose member.

6. The apparatus of claim 5, wherein said curved cylindrical tubular member and said straight cylindrical tubular member are attachably connected by way of a bell end fitting.

7. The apparatus of claim 5, wherein said straight cylindrical tubular member and said hose member are attachably connected by way of a cam and groove fitting.

8. The apparatus of claim 5, wherein said hose member and said filtration device are attachably connected by way of a cam and groove fitting.

9. A method of extracting and filtering fuel contaminants from a fuel tank while preventing an electrical charge from being formed by using an anti-static stinger apparatus, wherein said anti-static stinger apparatus comprises:
(a) a substantially straight cylindrical tubular member, having a first end and a second end, wherein said straight cylindrical tubular member is manufactured from a polyvinyl chloride composition comprising an anti-static additive incorporated into said composition during an extrusion process;
(b) a substantially curved cylindrical tubular member, having a first end and a second end, wherein said first end is inserted into a fuel tank and said second end is attachably connected to said first end of said straight cylindrical tubular member, wherein said curved cylindrical tubular member is manufactured from a polyvinyl chloride composition comprising an anti-static additive incorporated into said composition during an extrusion process;
(c) a hose member, having a first end and a second end, wherein said first end is attachably connected to said second end of said straight cylindrical tubular member, wherein said straight cylindrical tubular member, said curved cylindrical tubular member and said hose member are removably joined together to form a continuous fluid pathway; and
(d) a filtration device, comprising a power source and a pump, wherein said filtration device is adapted to connect to said hose member.

10. The method of claim 9, wherein said curved cylindrical tubular member and said straight cylindrical tubular member are attachably connected by way of a bell end fitting.

11. The method of claim 9, wherein said straight cylindrical tubular member and said hose member are attachably connected by way of a cam and groove fitting.

12. The method of claim 9, wherein said hose member and said filtration device are attachably connected by way of a cam and groove fitting.
